(19) United States
(12) Patent Application Publication
(10) Pub. No.: US 2016/0379155 A1
(43) Pub. Date: Dec. 29, 2016

(54) HORSE RACING MANAGEMENT SYSTEM, APPARATUS, AND METHOD

(71) Applicant: Allan Bennetto, Drumcondra (AU)

(72) Inventor: Allan Bennetto, Drumcondra (AU)

(21) Appl. No.: 15/192,462

(22) Filed: Jun. 24, 2016

Related U.S. Application Data
(60) Provisional application No. 62/183,875, filed on Jun. 24, 2015.

(30) Foreign Application Priority Data
Jun. 25, 2015 (AU) 2015902454

(51) Int. Cl. G06Q 10/06; G06Q 10/08; G06F 17/30; G06Q 20/10

(52) U.S. Cl. CPC G06Q 10/063114; G06Q 20/102; G06Q 10/087; G06F 17/30312

(57) ABSTRACT

There is disclosed an illuminating device for horse racing management system (HRMS) that stores, manages, tracks and provides data to various stakeholders. The HRMS may be used to provide efficient, secure information among and between different stakeholders based on permission levels and job descriptions.

This Application claims priority and the benefit of U.S. Provisional Application No. 62/183,875 and Australian Provisional Application No. 2015902454, which applications are incorporated by reference herein in their entirety.

### FIELD OF THE INVENTION

The present invention relates to a horse racing management system that may be used by trainers, owners, jockeys, staff, stable administrators, racing authorities, stewards and the like.

### BACKGROUND

Horse racing has existed for centuries and is watched by individuals in person, online, and on television worldwide. The information needed by staff, stable administrators, owners, trainers, racing authorities and others about the horse before, during and after a race has become essential to track the health, logistics, performance, and management of the horse as well as govern the rules of racing. Additionally, horse racing and associated management has become cumbersome to track, store, and manage. For example, existing methods of horse management are archaic, using inefficient methods with double handling of data, lost information, and time consuming information flows. Horse treatments are written on whiteboards and eventually handwritten into log books, and many times lost. There is little to no coordination about horses with their owners about the horse's progress.

Tracking of horse movements, track work, and performance is not reliable and not in real time or substantially in real time. Moreover, the track work is sometimes not even measured, because there ways to collect and store such information cumbersome. Schedules and results are handwritten or printed and left to a foreman to coordinate. In addition, tracking a horse's health, medication, and other treatment is not historically tracked, but rather only intermittently reported manually for each race. Authorities, such as horse racing authorities, also have little way of horse's history and whether that horse is clear to race in advance of a race.

Accordingly, there is a need for a system that takes raw horse data, e.g., name, owner, etc. along with information, such as treatment data, track work data, transport data, and efficiently reconciles such data in a secure, cost effective way and makes such data available to different stake holders.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### SUMMARY

In one aspect, a method is described for providing one or more stakeholders information relevant to one or more horses. The method includes electronically receiving raw horse data associated with respective of said one or more horses; electronically converting the raw horse data using a processor into one or more entries in a database of a memory device associated with the processor; electronically capturing one of treatment and track work information based on one or more attributes associated with at least one of the one or more horses;

electronically associating the captured one of treatment and track work information using the processor with at least one of the one or more entries in the database of the memory device;

electronically displaying information relevant to one or more horses, said displayed information being i) derived from the one or more entries in the database together with the associated one of treatment and track work information; and ii) limited depending on permissions associated with the one or more stakeholders.

In another aspect, the attributes comprise stride, cadence, distance travelled, speed, sectional times temperature, feeding amount, geographic coordinates, height or weight. The display information may be accessed from a mobile device, laptop, tablet, or a computer.

In another aspect, the method may include electronically communicating with one or more of the stakeholders via electronic messaging. The method may also include electronically permitting billing between stakeholders.

In another aspect, the method may include electronically permitting payment between stakeholders, capturing the one of the track work information and treatment information by implementing scanning technology, or electronically storing media data related to the one or more horses.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates an example of a horse racing tracking system in one embodiment.

FIG. 2 is a registration screen in an embodiment.

FIG. 3 illustrates an example of a trainer registration workflow in an embodiment.

FIG. 4 illustrates a workflow of to set permissions in an embodiment.

FIG. 5 illustrates a workflow of a horse list for trainer in an embodiment.

FIG. 6 illustrates a workflow for assigning one or more tasks to a staff member.

FIG. 7 illustrates a workflow for assigning a schedule in an embodiment.

FIG. 8 illustrates a workflow for tracking tasks in an embodiment.

FIG. 9 illustrates a workflow of communicating a message in an embodiment.

FIG. 10 illustrates a workflow for publishing content in an embodiment.

FIG. 11 is a workflow for an instant messenger in an embodiment.

FIGS. 12A-12B illustrate workflows for a payment module in an embodiment.

FIG. 13 illustrates a workflow for a data input in an embodiment.

FIGS. 14A-14B illustrate stakeholder access to the horse racing management system.

FIG. 15A shows a screen shot of a treatment tracker in an embodiment.

FIGS. 15B shows a screen shot of a track work tracker in an embodiment.

FIG. 15C shows a screen shot of a transport tracker in an embodiment.

### DETAILED DESCRIPTION

Each of the additional features and teachings disclosed below can be utilized separately or in conjunction with other features and teachings to provide a device, system, and/or method for a horse racing management system. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

Devices, methods, and systems are described for a horse racing management system (HRMS). In one embodiment, the system provides limited electronic access, functionality and information to one or more stakeholders. A stakeholder may be a trainer, staff, stable administrator, owner, medical personnel, jockey, steward, breeder, third party, retailer, or any other person or entity associated with horse racing. Each stakeholder may have the same or different access to information made available by the HRMS and in particular a secure database associated with the HMRS. It should be noted that references to “user” and “stakeholder” shall have the same meaning throughout the specification.

In one embodiment, the HRMS may provide general horse information, nominations, track work, location, medical data, multimedia, treatment data, stable management information, and other information associated with the horse. This information in the HMRS is derived from raw data received by the HMRS and converted using a processor into a data format usable by the HMRS. The converted data is stored as one or more entries in a database of a memory device associated with the processor. The information may be accessed using one or more tabs provided in a menu of items via a user interface. The HRMS may be configured in an embodiment to allow one or more stakeholders, such as the trainer, to electronically manage and limit access to data and to provide instructions and management data to other stakeholders. In other embodiments, the HRMS may be electronically configured to stakeholders' preferences, including the localisation of the training centre, track work, treatment details and prefixes.

In other embodiments, a stakeholder may download and/or provide data in to the HRMS and/or a stakeholder may track visually or by reading updates an activity of the horse. In one embodiment, the HRMS may be configured to provide information necessary to comply with local horse racing rules and regulations, such as enabling access to treatments that a horse has had, is having, or is expected to have.

In one embodiment, the HRMS is a secure, modular portal that allows access to and control of content based on privacy, security, and other options. For example, the HRMS may include a login that requires a name and a confirmation and storage of identification information about the stakeholder. Various authentication procedures may be used. A user's profile may include name, email and password, tagline, location, stable name, avatar, address, and other contact related details.

In one example, notifications may be used to limit or provide access requests, owner access requests, task completed including treatments, transport, and whether a new horse is added. Authority notifications may also be provided. A search option may also be provided to search information in the HRMS.

The HRMS may also include visibility settings showing a status of a stakeholder such as private or availability to certain stakeholders. In one example, the HRMS may accept data via an XML feed of raw horse data from one or more sources. Such data may be updated, edited, or otherwise changed. Data to the HRMS may be provided in textual, audio, and/or video.

The HRMS may include a digital biological passport that includes the breeding history, health history, treatment history, and other biological data concerning the horse. In some embodiments, the HRMS may also include a booking system for jockeys based on their availability and riding weight.

The HRMS may also include a market place and a stock module for ensuring that the stable and associated components are adequately supplied. Automatic and recurring supply techniques may be used to ensure that the stock does not pass below a certain threshold. Additionally, third party merchants may be able to interact with other stakeholders to purchase necessary goods related to the horse.

The HRMS may also include a trainer invoice builder that enables the trainer to select various events that are billed at the time the event is scheduled or completed, instead of a reconciliation at the end of a billing period. In other embodiments, the HRMS may also bill more than one party based on percentage ownership of a horse.

The HRMS may also serve as an online marketplace to auction, buy, or acquire shares in a horse. In other embodiments, the HRMS may be used to control via an interface into a third party system nominations, acceptances, scratches, jockeys, gears and owner registrations.

In some embodiments, a polling system may be integrated into the HRMS to allow stakeholders to make democratic decisions about the horse. The HRMS may also be configured to manage payroll for stakeholders and may use one or more scanning technologies, such as RFID, to clock in and out for shifts and also when a task, such as track work is being performed or treatment administered.

The HRMS may also include software and hardware for electronically capturing track work and treatment information and also monitor heartbeat and location using GPS to manage the performance of the horse. Attributes that may be used include stride, cadence, distance travelled, speed and sectional times. Other data may also be measured, such as temperature, feeding amount, geographic coordinates, and other biological information, such as height and weight.

The HRMS may also be configured to support media content. In one embodiment, the HRMS may receive a live, delayed, or recorded audio and/or video from a drone or other recording device.

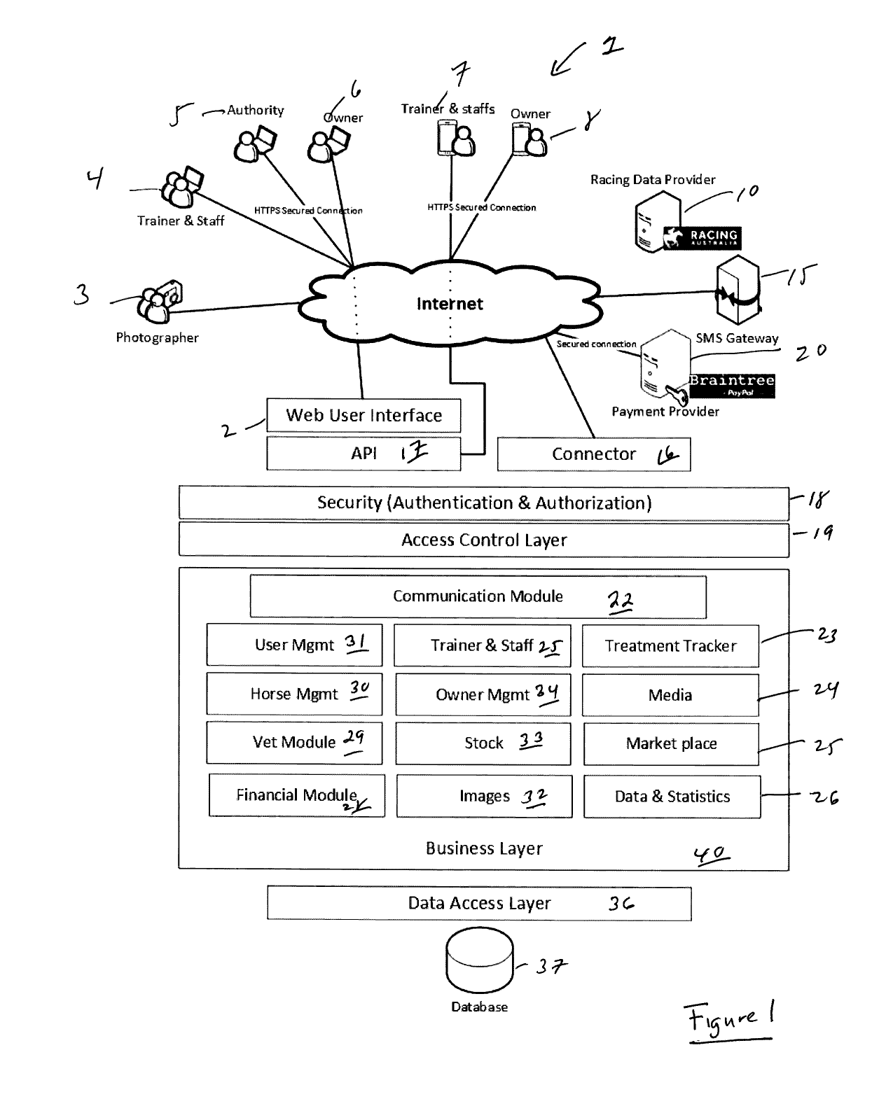

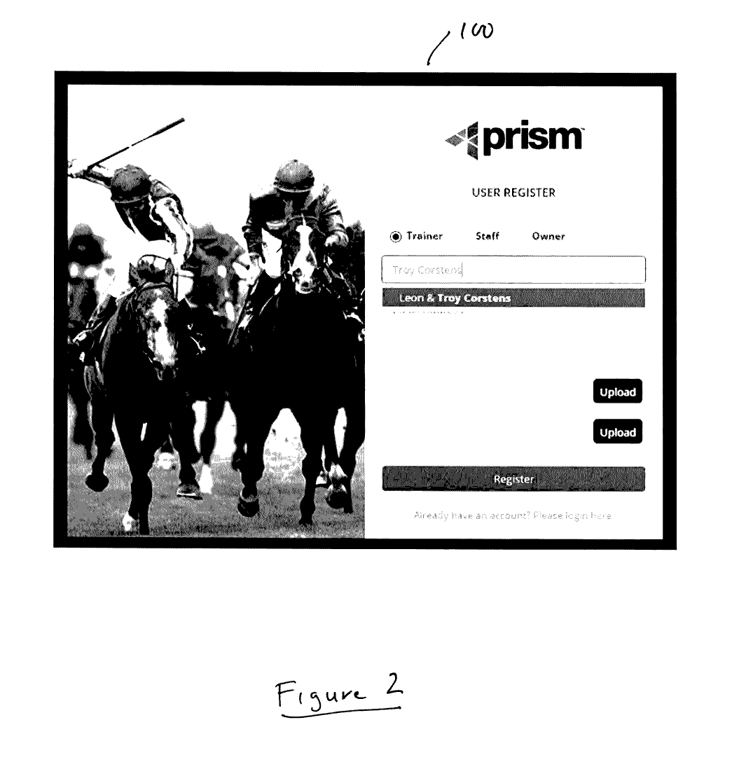

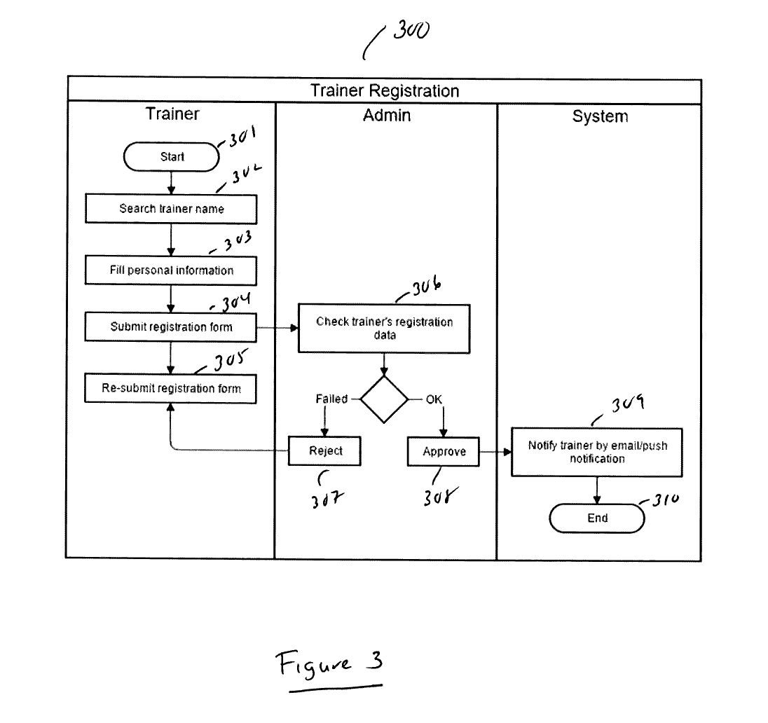

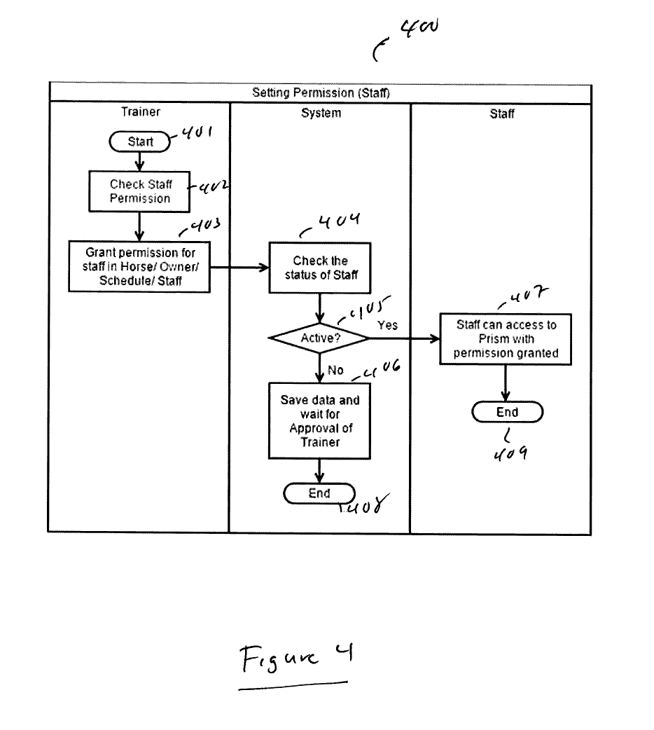

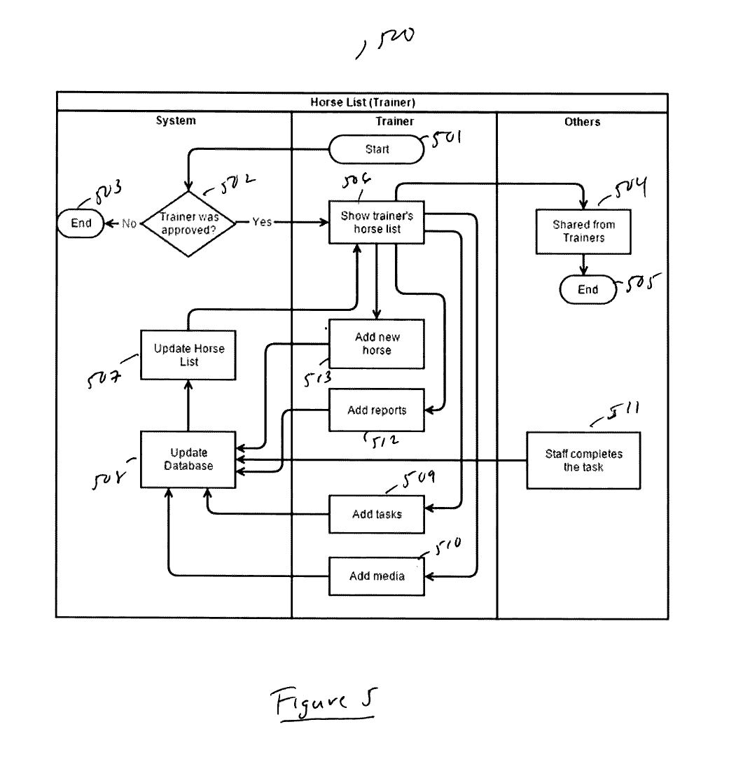

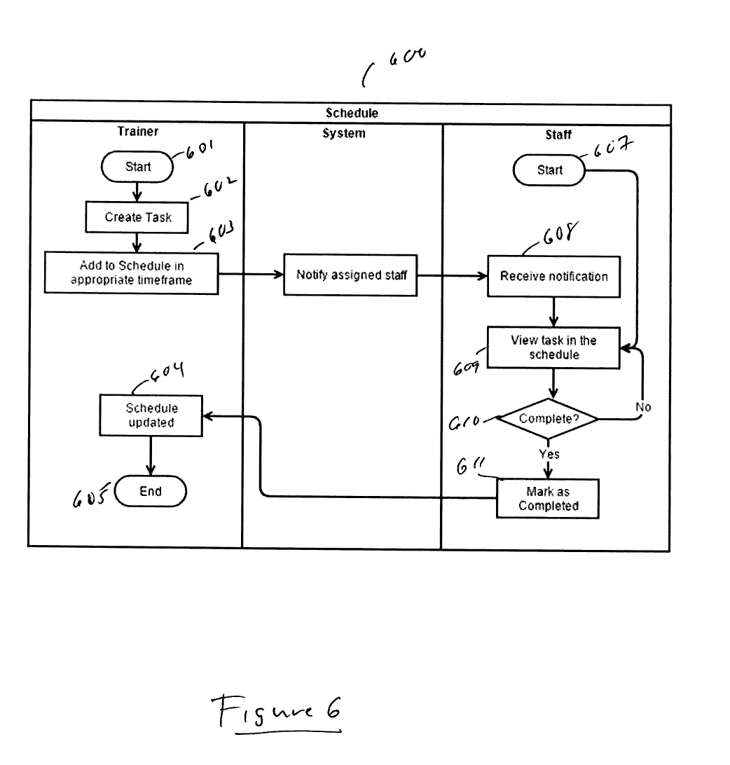

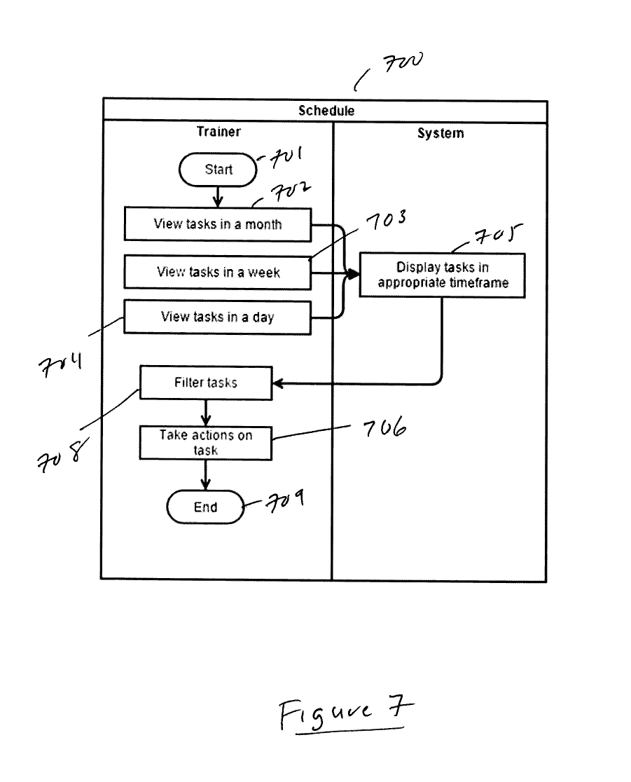

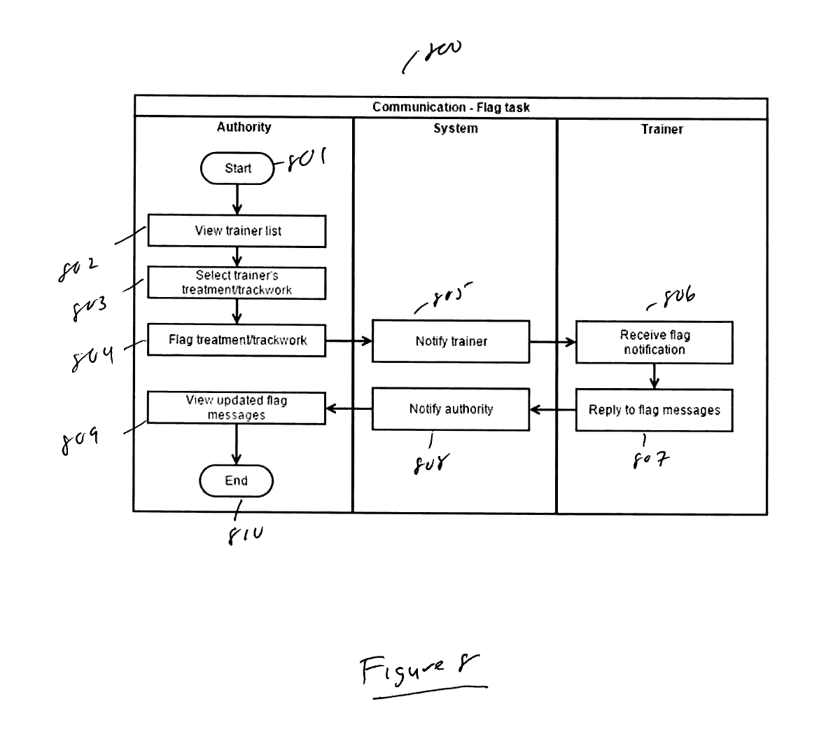

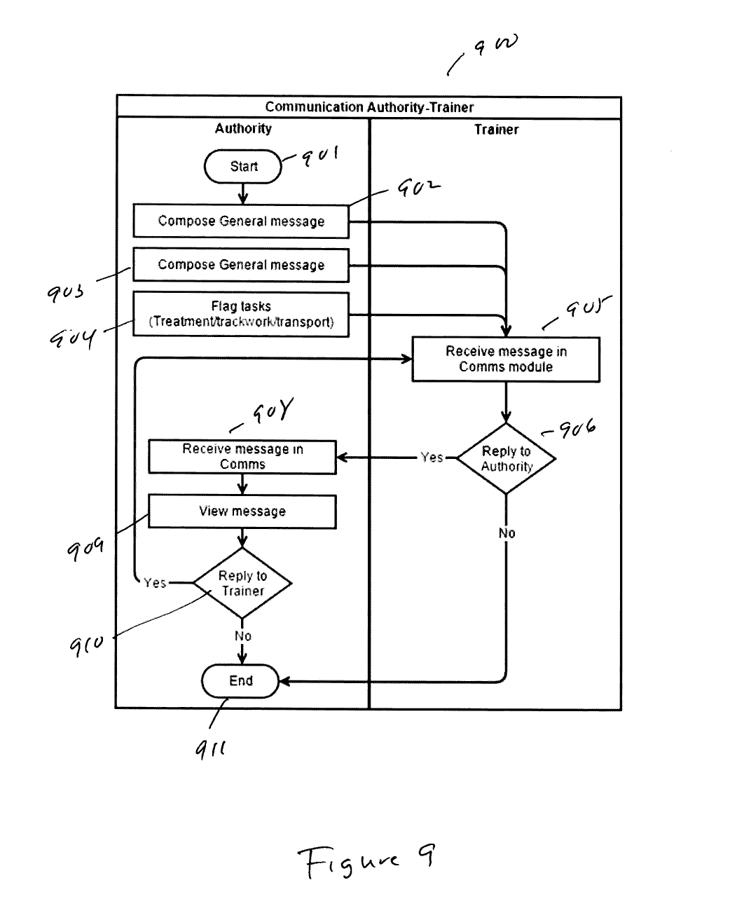

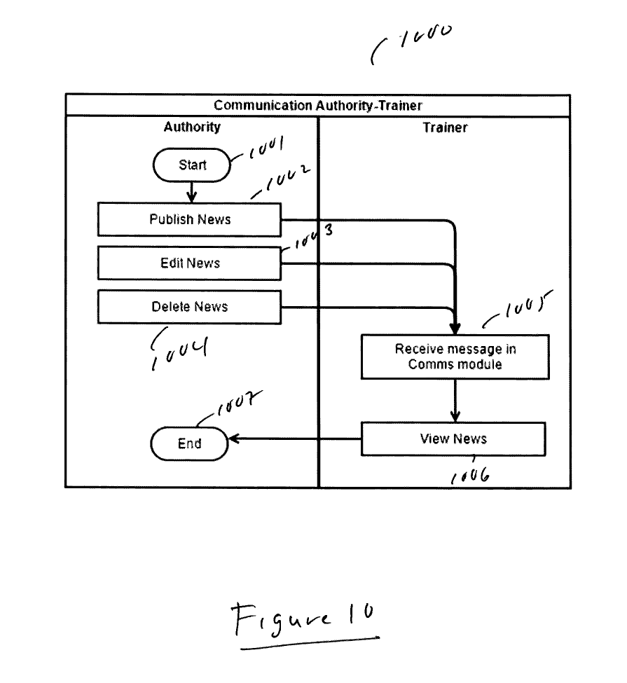

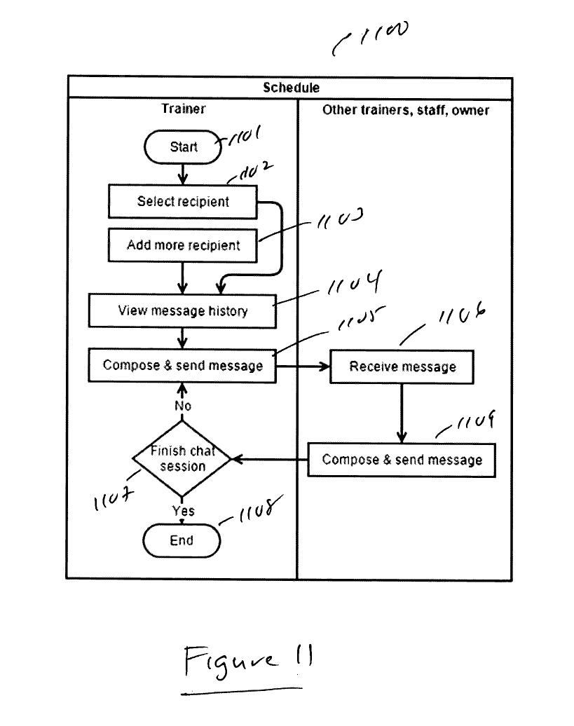

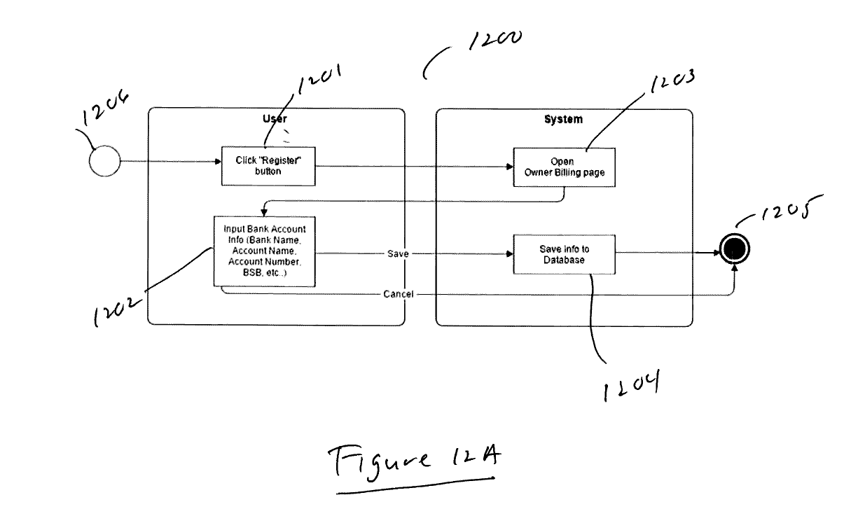

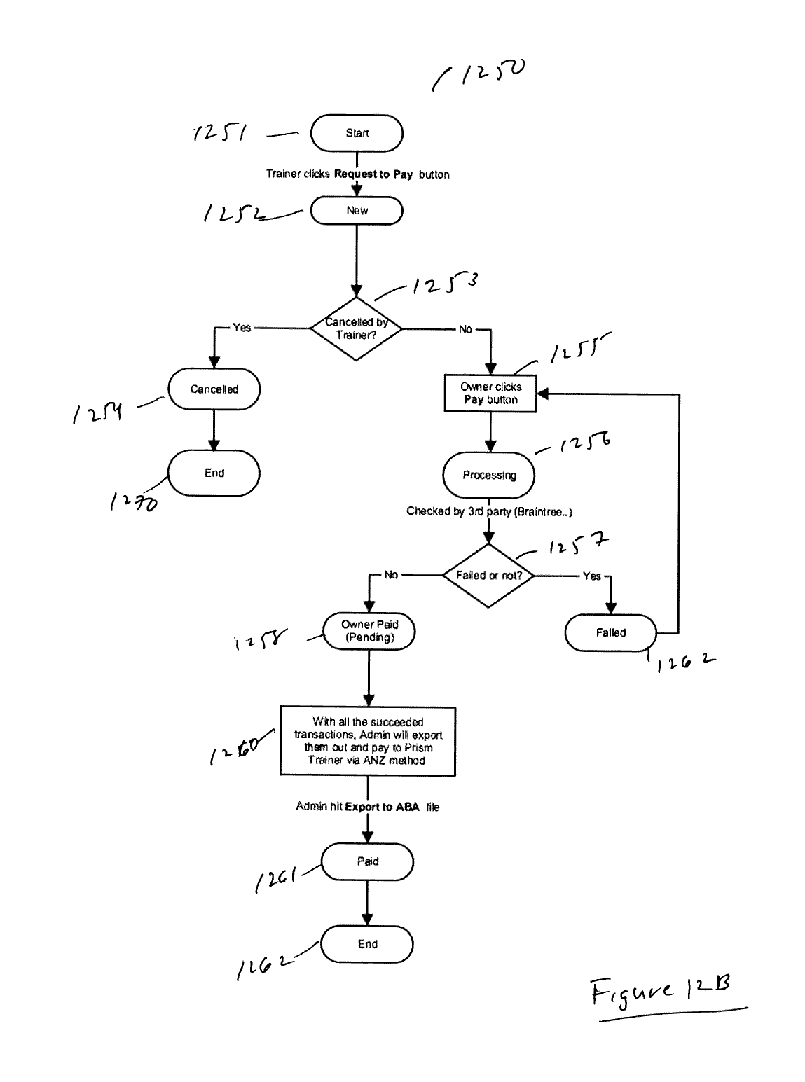

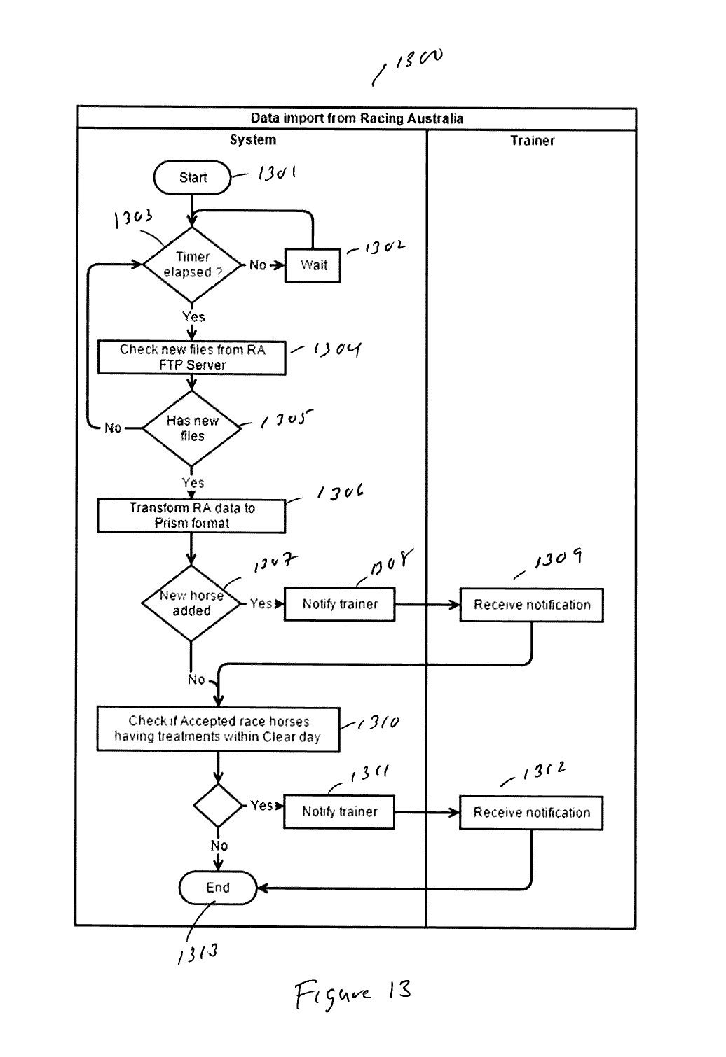

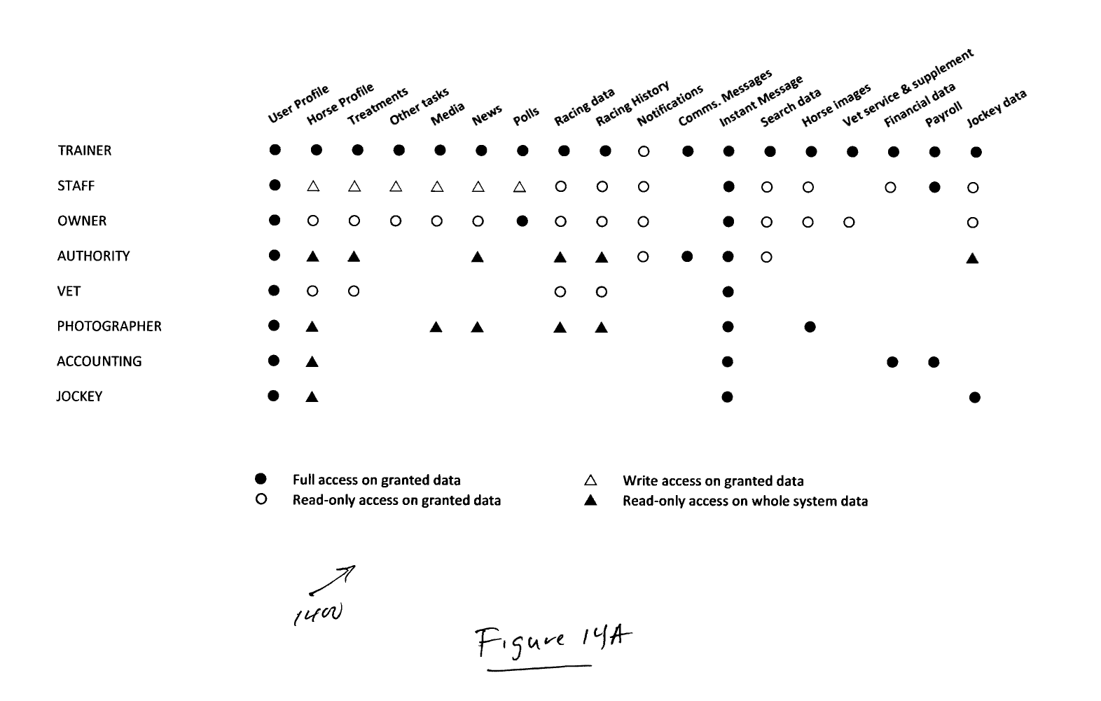

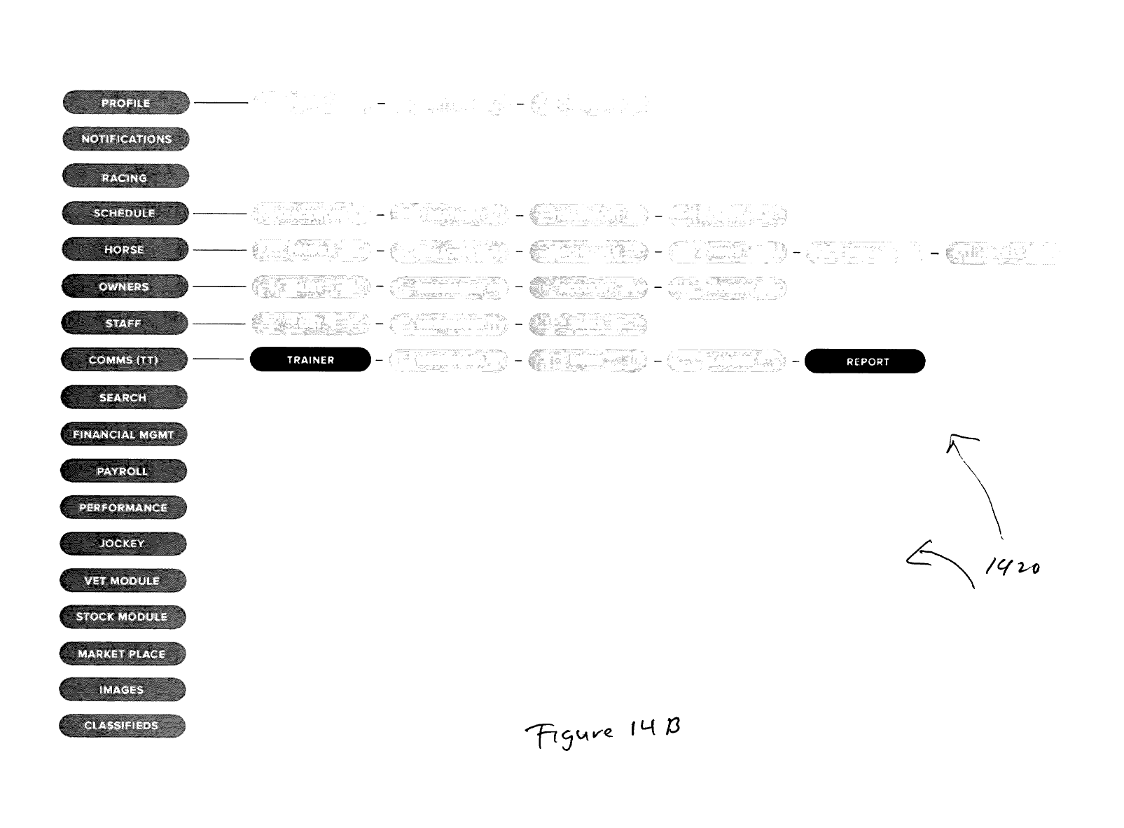

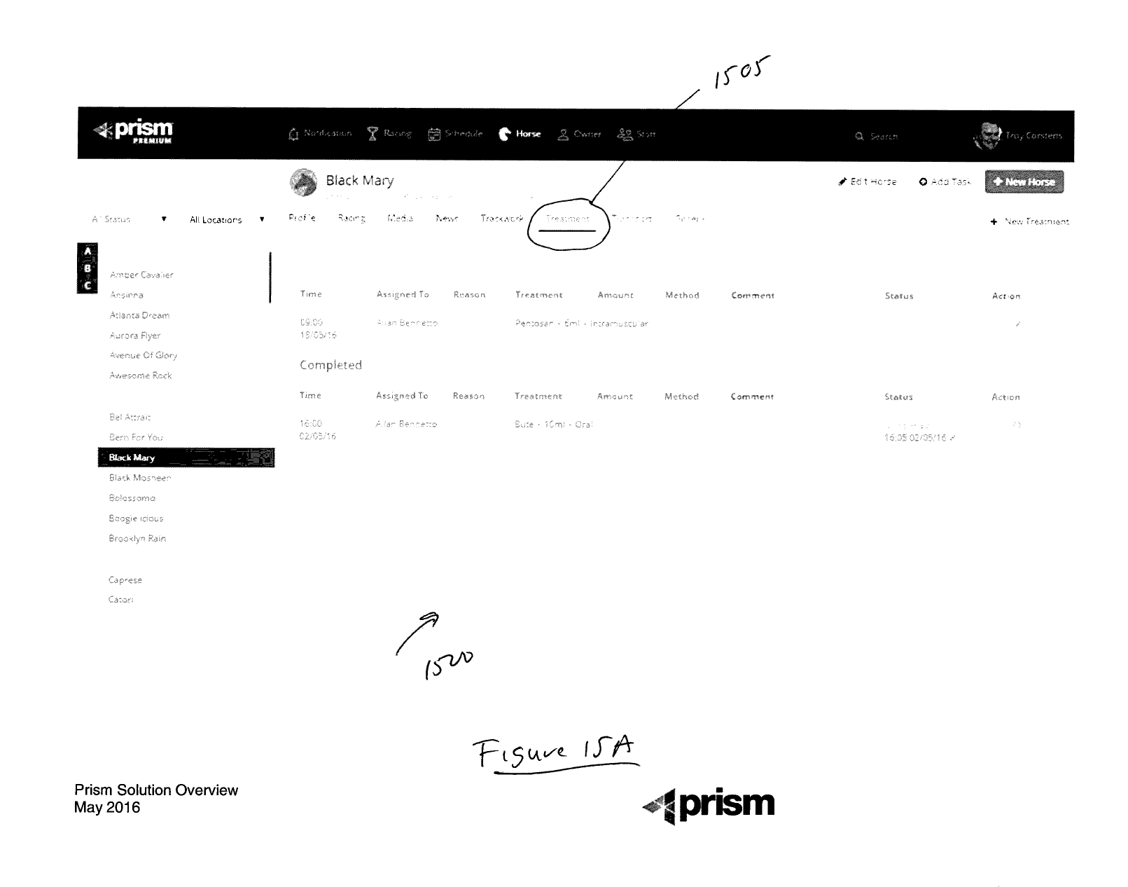

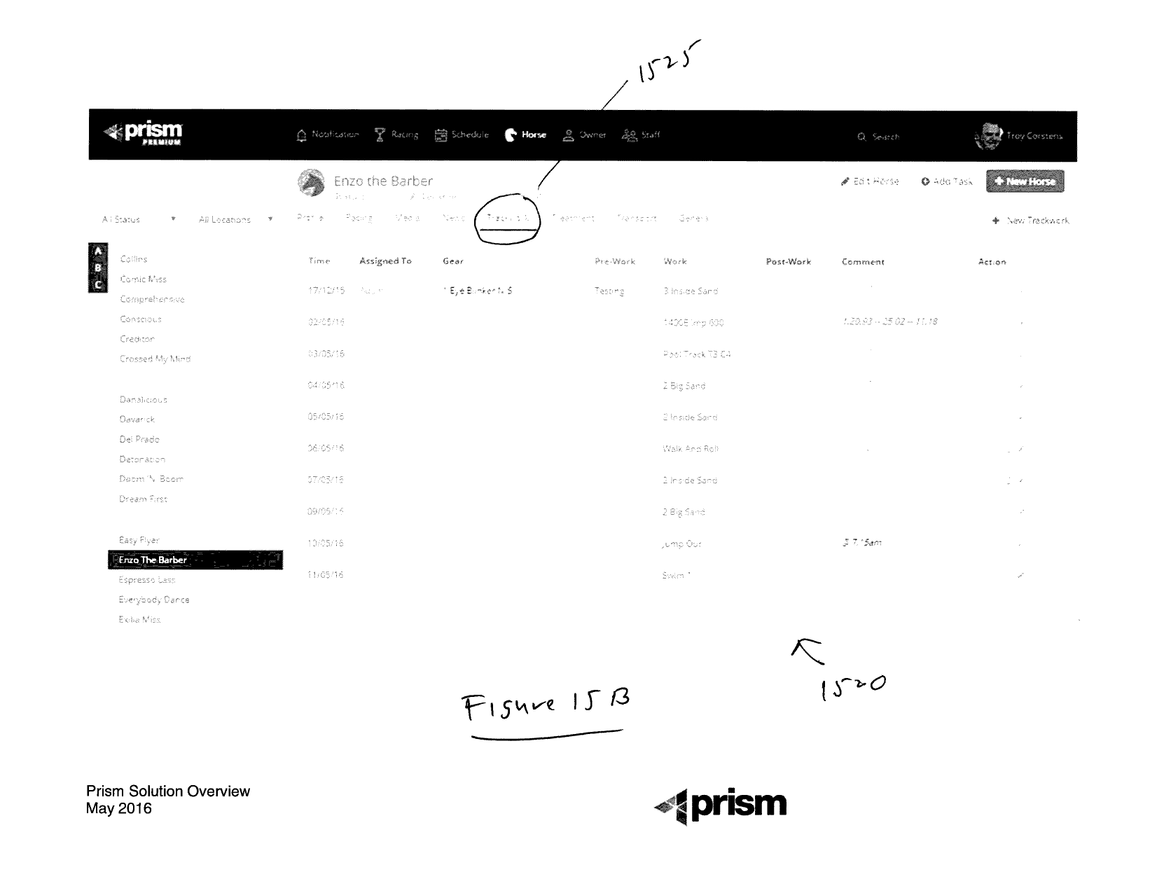

An example of the HRMS is shown in FIG. 1. The HRMS 1 may communicate with one or more stakeholders 3-8 over a network 9, such as the Internet or other private or public network. In one embodiment, the stakeholders 3-8 may communicate over network 9 via a web user interface layer 2 A request from this layer to a back-end system 17 e.g., API Layer may be filtered by a security layer 18 to avoid any unauthorized access. A stakeholder may also communicate with the HRMS via a mobile application over a cellular, wife, or similar network. A stakeholder may use a mobile device, a laptop, a desktop computer, PDA, a tablet, or other device to communicate with the HRMS.

In one embodiment, stakeholders may use the mobile application with a barcode or microchip reader to read horse data on the field and transmit the results to the HRMS. The HRMS may also include connector layer 16, which includes a combination of software and hardware modules and/or components that interact with other external system to update one or modules of the HRMS, including one or more databases 37 associated with a processor (not shown) via database access layer 36. In one embodiment, the connect layer 16 may also be used also when the HRMS communicates to a stakeholder via external providers, such as push notification provider, racing data provider 10 SMS gateways 15 and a payment provider 20.

The security layer 18 may include authentication and/or authorization. The authentication module may be used to authenticate a stakeholder of the HRMS. The authorization module may be used to restrict access to features and limit the electronic display of information based on and corresponding to authenticated stakeholder's role. The API layer 17 may be a set of RESTful web services which are secured by HTTPS protocol.

An access control layer 19 may be configured as part of the HRMS security mechanism, the where every managed domain object is privately accessed only by corresponding authorized stakeholder. For example, a trainer may only access information related to a particular horse and training data. Other trainers, even authenticated to HRMS, may not have right to access this data.

In one embodiment, a business layer 40 may include components including software and hardware that implement business rules and manage data of the HRMS. The data access layer 36 may also be to provide data persistence job to/from platform's database server 37.

The business layer 40 may include a communications module 22 that is configured to communicate with the software and hardware components that execute one or more business rules for one or modules including user management 31, which handles profiles, settings, permissions, approvals, notification, registration and other like procedures. Horse management 30 handles all data about the horse, including its name, trainer name, health profile, race history, and the like. A vet module 29 handles treatments for the horses, and the financial module 28 handles all information related to billing 28. The trainer and staff 35 module handles all data and details associated with owner and staff, including assigning tasks and calendars. Owner management 34 includes all information about the owner, including which horses the owner owns, their banking or account details, and the like. Stock module 33 manages inventory of the stable. Images module 32 is a portal for third parties to upload images of a specific horse. Treatment tracker module 23 tracks the treatment and track work of a horse which is electronically captured from measured attributes associated with the horse. Media module 24 controls all media, such as social networking, articles, audio, and video files. The market place module 25 may be used to integrate third parties with stake holders to purchase goods for the horse, stable, and the like. Data and statistics module 26 may be used to analyse trends for performance and health management and similar algorithms of the horse.

FIG. 2 shows a registration screen 100 that shows allows a stakeholder, such a trainer, staff, and/or owner to register with the HMRS. In one embodiment, a stakeholder may be asked to create a login and password along with uploading identification, such as a driver's license or a trainer's certificate.

FIG. 3 illustrates a workflow 300 to register a trainer. At 302, the HMRS searches for the trainer's name in the system. If name is not found, the trainer completes a registration form at 303 and submits the form at 304. At step 306, the HMRS checks to see if the registration data is valid. If it is valid, the HMRS approves the data at step 308 and notifies the trainer by email push notification at 309 and 310. If the registration data it is not valid, the information is rejected at 307, and the trainer is prompted to resubmit the registration form with accurate information at 305.

FIG. 4 for shows a setting permission workflow 400 in an embodiment. At 402, the stakeholder permissions are checked. If the stakeholder does not have the permissions, at 403, permissions are granted for the stakeholders. At 404, the status of the stakeholder is checked. If the stakeholder's permissions are active, then the stakeholder may proceed to access the authorized components of the system and for example view information relevant to one or more horses, this information having been derived from treatment and track work information electronically associated with one or more entries for horses in the HMRS database. If the status of the stakeholder is not active, the data will be saved and approval will be required by the trainer at 406.

FIG. 5 shows a workflow for a horse list 500. At 502, it is determined if the trainer was approved. If the trainer was not approved, the process ends at 503. If the process was approved at 502, a horse list for the trainer is shown in 506. The horse list may be shared with other trainers at 504. Referring again 506, a new horse may be added at 513. Additionally, reports may be added at 512, tasks maybe added at 509, and media may be added at 510, any of which may update the database at 508. Additionally, when a stakeholder completes a task at 511, the database may be updated at 508. Any update of the database at 508 may generate an updated horse list at 507, which then maybe passed at 506.

FIG. 6 illustrates a workflow for assigning tasks 600. At 602, task is created. At 603, a task is added to a schedule at a selected time. At 606, an appropriate stakeholder is notified of the task. At 608, the stakeholder receives notification of the task. At 609, the stakeholder may view the task in their schedule, and at 610 the system determines whether the task is complete. If the task is complete, it is marked as such at 611, and the schedule is updated at 604. If at 610, the process is not complete, then the stakeholder may view the task at 609 or start the task at 607.

FIG. 7 illustrates a process of viewing one or more tasks in an embodiment. In 702, 703, 704, the stakeholder may view tasks in a month, week, or day, respectively. At 705, the task may be displayed in accordance with the desired view. At 708, tasks may be filtered, and at 706, actions may be taken to complete the task.

FIG. 8 shows a workflow 800 for tasking flags for treatment of track work. At 802, a trainer list may be viewed. At 803, the trainer's treatment or track work may be selected 804 by the authority. At 804, the treatment or track work may be flagged. At 805, the system notifies the trainer, and at 806, the trainer may receive the flag notification. At 807, the trainer may reply to the flagged messages, and at 808, may notify the authorities. At 809, the authority may view the updated flag messages.

FIG. 9 shows the authority/trainer communication workflow 900 in an embodiment At 902, the authority make compose an alert message, at 903 compose a general message, or at 904 compose a flag task for treatment for track work or transport. At 905, the trainer may receive the message and reply to the message at 906. The authority may receive the reply message at 908, view the message at 909, and reply to the trainer at 910.

FIG. 10 shows a workflow 1000 for a media application. At 1002 news may be published, at 1003 news maybe edited, or at 1004 news may be deleted, by the authority. At 1005, the trainer may receive the news in the system, and at 1006 view the news.

FIG. 11 shows a workflow for instant messaging 1100 in embodiment. At 1102, a recipient maybe selected. At 1103, more recipients may be added. At 1104, the message history may be viewed. At 1105, a message maybe composed and sent by the trainer. Other stakeholders may receive the message at 1106, and compose and send a reply message or an initial message at 1109. The session may end 1107 at may proceed back to 1105.

FIG. 12A a shows a workflow 1200 for entering payment. At 1201, the registration process may begin by activating a register button or other similar means. At 1203, the system may open a billing page and banking, credit card, or other account information may be added at 1202. The system may be updated at 1204.

FIG. 12B shows a workflow 1250 for requesting an invoice. At 1252, the system may receive a request for the payment of an invoice. At 1253, the system determines whether the invoice was canceled by the trainer. If so, at 1254, the invoice is canceled. If no, a notification from the owner to process the invoice may occur at 1255, and the invoice may be processed and reconciled internally by the system or buy a third-party at 1256. At 1257, it is determined whether the invoice had failed or not. If the invoice did not fail, at 1258 the owner's payment is pending. At this time, the system will receive in one embodiment, payment by a third-party at 1260, and then export payment to the trainer at 1261. If the processing failed, at 1262, the process will revert back to 1255. In one embodiment, the invoice may be reconciled outside of the HRMS, but the invoice status may be updated within the system.

FIG. 13 illustrates a workflow 1300 for importing data about horses. At 1303, the system looks for new information. If a timer has elapsed the system looks for new files at a third-party FTP server at 1304. If the timer has not collapsed at 1302, the process will wait for the timer to lapse. At 1305, if there are new files, the data may be transformed or converted from its raw data format using a processor of the HRMS into a format usable by the HRMS. If there are no files, the process may return back to step 1305. At 1307, it is determined whether a new horse has been added. A trainer may then be notified at 1308, and receive a notification at 1309. If no new horses are added, the system may check if the accepted horses have treatment within a clear day at 1310. A clear day may be defined as the number of days estimated for a horse to be free of a relevant treatment. For example, a treatment with a seven “clear day rule” means that a horse should not race until eight days after the specific treatment to ensure the horse is free of the relevant medication or symptom. If the treatment may occur, the trainer may be notified at 1311 and may receive a notification at 1312.

FIGS. 14A-14B show various options that a stakeholder may access in the system. As shown in FIG. 14B, each stakeholder may have a portal 1400 that includes one or more options that may be accessed depending on the access level of the stakeholder. As shown in one embodiment in in the chart 1400 of FIG. 14A, the stakeholder may have access to certain ones of the different features or modules of the HRMS.

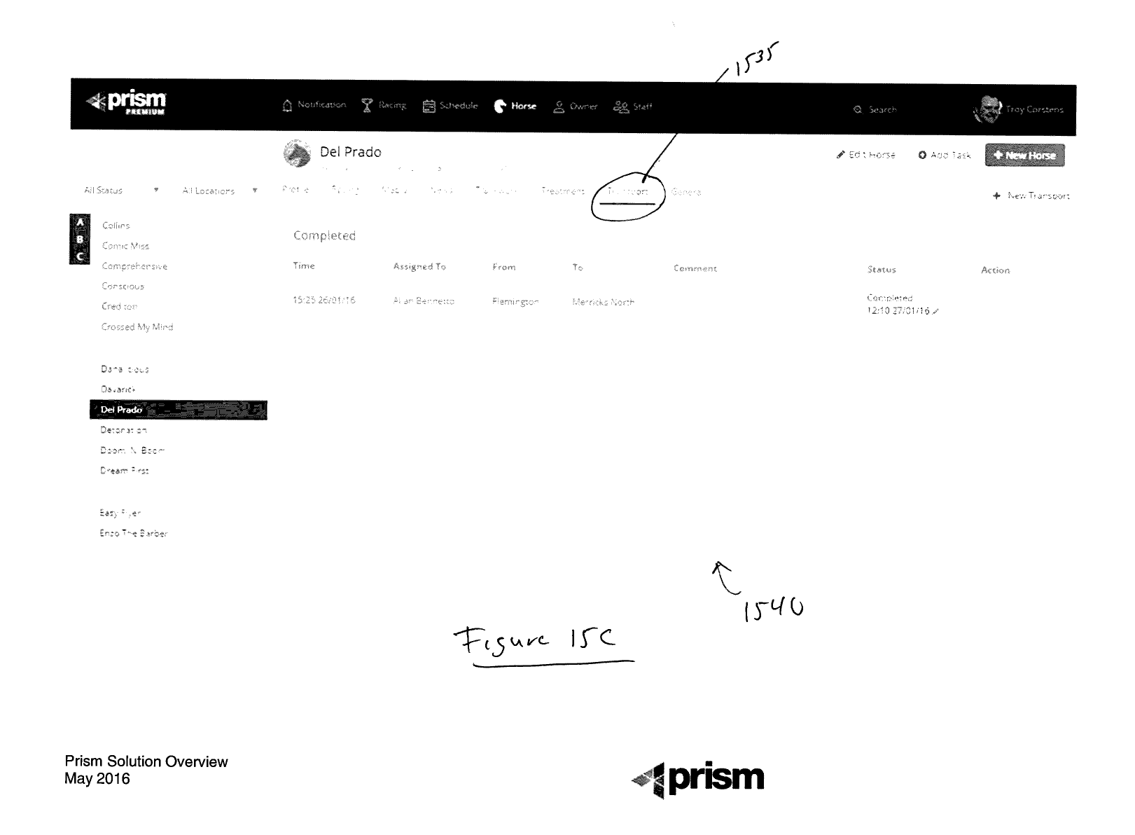

FIG. 15A shows a screen shot of a treatment tracker 1500 in an embodiment. As shown, when treatment tab 1505 is selected, the system may track one or more of the following for a horse, such as “Black Mary”: time/date, the person assigned to the treatment, reason for the treatment, the amount, the treatment prescribed, the status of the treatment, and when the treatment is completed. Other data may be part of or be electronically captured and stored in the treatment tracker.

FIGS. 15B shows a screenshot of a track work tracker 1520 in an embodiment. When the tracker tab 1525 is selected, the system may track or measure one or more of the following attributes of a horse, such as “Enzo the Barber”: time/date, the person assigned to the track work, the gear, pre-work, work, post work, comments, and any action to be taken. Other data may be part of or be electronically captured and stored in the track work tracker.

FIG. 15C shows a screen shot of a transport tracker 1540 in an embodiment. When the transport tab 1535 is selected, the system may track one or more of the following of a horse, such as “Del Prado”: time/date, the person assigned to the track work, the transport from and to, comments, the status of the transport and any other action required. Other data may be part of or be electronically captured and stored in the transport tracker.

The HRMS may be configured to provide to stakeholders a complete real time end-to-end communication bus via various type of mediums. Track work data and treatment data may be electronically captured in real time or substantially in real time and may be based on one or more attributes of the horse. In one example, web interface notifications may be implemented such that when a stakeholder connects to the HRMS web interface, notifications are received in a WebSocket implementation. In another embodiment, push notifications to mobile device may be received if a stakeholder connects to HRMS on a mobile device. The stakeholder may also receive SMS and/or email notifications: some type of notifications may be sent by SMS and email.

In one embodiment, the web interface may be built using Single Page Application (SPA) model using an AngularJS framework and may be supported by a known web browser. The HRMS may also be configured using J2EE technology using Spring framework. Such a solution may provide a large scalable system and solid built-in security framework.

In one example, the HRMS may include a secured data connection that enables data transferred between web user interface/mobile applications and back-end system in a secured HTTP connection using SSL protocol. In one example, data may be encrypted and cannot be intercepted. In another embodiment, cross-site request forgery (CSRF) may be used in which a CSRF security token may be used in every request from web user interface to allow the HRMS to detect and deny requests from unauthorized locations.

The HRMS databases may use data encryption and/or hashing. Stakeholder session validation and expiration may also be used in which after a successful login, a stakeholder's session will be expired after a configured amount of time.

The HRMS may accept raw horse data from any third party platform and electronically convert that data into one or more entries in the HMRS database. The data may include horse race results, history, stats, nominations, and the like. Pedigree information may also be provided.

The HRMS may also include hardware and software that may be used to measure track work and horse performance including the recording of training sessions using GPS, heart rate monitor, speed and stride monitor, track upload and mapping, manual stopwatch or GPS.

In other embodiments, the HRMS may include GPS location stamping during treatment administration, photo/video recording with location and date timestamp for treatment administration, mobile device microchip scanning of horse date using RFID scanners, NFC, or the like.

The HRMS allows for data to be collected from a variety of previously uncollected resources related to horse racing and make that data available in a secure forum that limits access and provides the ability to manage all data associated with a horse. In one embodiment, the system also allows for transparency with treatments, medications, and obeying clear day rules.

The HRMS may also be used to process other types of data, including the tracking of growth of plant life, its distribution, its users, and payment for such plant life. In other embodiments, the components and modules of the HRMS, such as financial and the communication module may be used for other types of data.

Below represents exemplary pseudocode for various operations of the HRMS. Each function starts with a “#.”

# read the meeting from file, each received file contains only 1 race
meeting with meeting in received file:

# verify existing meeting in database is older than importing one

if meeting.status is older than current:

break;

# loop through all races and race entries in importing race meeting

foreach race in meeting.races:

foreach entry in race.entries:

# create/update trainer

trainer = get_trainer( );

if trainer.is_new or trainer.is_updated:

update_trainer_to_db(trainer);

# update horse info & statistics

horse = update_horse_trainer(trainer);
if horse.is_added or horse.is_removed:

notify_trainer(new_horse);

update_horse_statistics(horse, meeting.status)

# update jockey database

jockey = get_jockey( );
update_jockey_to_db(jockey);

# update past races (last starts)

past_races = get_past_races( );
update_horse_past_races(horse, past_races);
# treatment processing:
# if a treatment already taken is in a category with [clear
days] after race date
# trainer must be notified to get horse scratched from race
treatments = get_horse_treatments(horse);
foreach treatment in treatments:

if treatment.clear_days < race.date:

notify_trainer(treatment);

end for;

```
  # update race entry information
  merge_race_entries(race.entries);
end for;
# update races information into existing races
merge_races(meeting.races);
end with;
```

The present invention or any part(s) or function(s) thereof, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . .”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A method of providing one or more stakeholders information relevant to one or more horses, said method comprising the steps of:
electronically receiving raw horse data associated with respective of said one or more horses;
electronically converting the raw horse data using a processor into one or more entries in a database of a memory device associated with the processor;
electronically capturing one of treatment and track work information based on one or more attributes associated with at least one of the one or more horses;
electronically associating the captured one of treatment and track work information using the processor with at least one of the one or more entries in the database of the memory device;
electronically displaying information relevant to one or more horses, said displayed information being:
derived from the one or more entries in the database together with the associated one of treatment and track work information; and
limited depending on permissions associated with the one or more stakeholders.

2. The method of claim 1, wherein the attributes comprise one of stride, cadence, distance travelled, speed, sectional times temperature, feeding amount, geographic coordinates, height and weight.

3. The method of claim 1, further comprising accessing the display information from one of a mobile device, laptop, tablet, and a computer.

4. The method of claim 1, further comprising electronically communicating with one or more of the stakeholders via electronic messaging.

5. The method of claim 1, further comprising electronically permitting billing between stakeholders.

6. The method of claim 1, further comprising electronically permitting payment between stakeholders.

7. The method of claim 1, further comprising capturing the one of the track work information and treatment information by implementing scanning technology.

8. The method of claim 1, further comprising electronically storing media data related to the one or more horses.

9. An apparatus including a memory and a processor, the processor executing instructions for providing one or more stakeholders information relevant to one or more horses, said instructions including:
electronically receiving raw horse data associated with respective of said one or more horses;
electronically converting the raw horse data using a processor into one or more entries in a database of a memory device associated with the processor;
electronically capturing one of treatment and track work information based on one or more attributes associated with at least one of the one or more horses;
electronically associating the captured one of treatment and track work information using the processor with at least one of the one or more entries in the database of the memory device;
electronically displaying information relevant to one or more horses, said displayed information being:
derived from the one or more entries in the database together with the associated one of treatment and track work information; and
limited depending on permissions associated with the one or more stakeholders.

10. The apparatus of claim 9, wherein the attributes comprise one of stride, cadence, distance travelled, speed, sectional times temperature, feeding amount, geographic coordinates, height and weight.

11. The apparatus of claim 9, further comprising accessing the displayed information from one of a mobile device, laptop, tablet, and a computer.

12. The apparatus of claim 9, further comprising electronically communicating with one or more of the stakeholders via electronic messaging.

13. The apparatus of claim 9, further comprising electronically permitting billing between stakeholders.

14. The apparatus of claim 9, further comprising electronically permitting payment between stakeholders.

15. The apparatus of claim 9, further comprising capturing the one of the track work information and treatment information by implementing scanning technology.

16. The apparatus of claim 9, further comprising electronically storing media data related to the one or more horses.

17. A method of providing one or more stakeholders information relevant to one or more horses, said method comprising the steps of:
electronically receiving raw horse data associated with respective of said one or more horses;
electronically converting the raw horse data using a processor into one or more entries in a database of a memory device associated with the processor;
electronically capturing one of treatment and track work information based on one or more attributes associated with at least one of the one or more horses;
electronically associating the captured one of treatment and track work information using the processor with at least one of the one or more entries in the database of the memory device;
electronically displaying information relevant to one or more horses, said displayed information being derived from the one or more entries in the database together with the associated one of treatment and track work information.

18. The method of claim 17, further comprising electronically limiting access to the displayed information as a function of the type of stakeholder.

19. The method of claim 17, further comprising capturing one of treatment and track work information in real time.

20. The method of claim 17, further comprising accessing the displayed information from one of a mobile device, laptop, tablet, and a computer.
